(19) United States
(12) Patent Application Publication
(10) Pub. No.: US 2012/0211528 A1
(43) Pub. Date: Aug. 23, 2012

(54) Beer/soda bottle spray adapter

(76) Inventor: Patrick Greeley, Gridley, CA (US)

(21) Appl. No.: 12/932,132

(22) Filed: Feb. 18, 2011

(51) Int. Cl. B05B 9/01; B05B 9/043

(52) U.S. Cl. 222/383.1; 239/333

(57) ABSTRACT

An adapter sized to fit on a short-neck or long-neck beer or soda bottle or upon a non-gas containing fluid bottle having a similar opening size, which adapter is interposed between a spray gun and the bottle to permit the content of the bottle to be sprayed onto food stuffs to add spice or a flavorant to the food. The adapter has two portions, the first of which is a cylinder of flexible preferably clear plastic having a distil end and a proximal end. The proximal end being unthreaded but sized in diameter to engage the area around the bottle's top opening, be it threaded or not. The distil end of the adapter device has a second portion attqached thereto, which is a set of threads that will engage the female threads of the rotatable cap of a sem-typical liquid spray gun.

### FIELD OF THE INVENTION

This invention relates to a releasably secured adapter to convert a beverage bottle into a vessel from which the content can be sprayed onto a substrate

### BACKGROUND OF THE INVENTION

Adaptors, also know as adapters, for converting or modifying an item from a first use to achieve a second use are one of the ribs attached to the backbone of American technological improvements. Thousands of patents have issued on articles and processes to convert item or process A to a new use as an item B or a new way to utilize item A.

One example of such an adapter innovation is published U.S. Patent application 2006/0151420. Which relates to an adapter for a baby bottle nipple to create an extension on a baby bottle for the child to hold. U.S. Pat. No. 5,024,341 is a related adapter for a slightly different bottle.

The Snyder U.S. Pat. No. 5,253,900 pertains to a container conversion adapter for coupling a reservoir of hand held airbrushes to a commercial liquid media container to permit the user to utilize the container, IE. The bottle as the airbrush liquid media reservoir. That is the bottle is created to the “container to hold the airbrush liquid that attaches to the gun, such that one need not pour fluid from the container into a separate reservoir that attaches to the airgun.

Two other adapters known to applicant are the Palinchuk U.S. Pat. No. 5,947,324 which cites the Esposito U.S. Pat. No. 5,071,042. Both of these pertain to adapters that attach to the top of a beer or soda can and which adapters are generally pear shaped with a threaded top, such that the user has the feel and feeling of drinking from a bottle and not from a can. In both cases, the fluid in the can exits the pull tab area and flows through the snap on adapter and out the mouth of the bottle converter.

None of these patents are deemed to be prior art to the invention of this patent application, but merely serve as examples of American ingenuity to adapt one thing into a completely different article.

Many Americans, and Canadians too, enjoy the use of a charcoal or gas fired barbecue unit. Many of these people like to add flavorants such as mesquite, or maple, or lemon, or even soda such as Coca Cola® to their meet, fish or sea food.

These same outdoor chefs also on occasion have fire flare-ups from fat dripping from meat, or olive or other oil dripping from shrimp, onto the hot coals or gas grids from which exit burning gas of your barbecue unit.

For these chefs, it would indeed be wonderful if they had a way of easily adding flavorants or liquid smoke or liquified herbs and marinades to food stuffs. It would also be beneficial for them that if indeed a fire started that the chef had an easy to spray fluid onto the fire to put out the flame.

It is one object therefore to provide an adapter to fit on a short or long neck soda bottle or beer bottle such that fluid in such container be it original or replacement fluid such as tap water may be spritzed out using a prior art spray gun onto a substrate.

It is another object to provide an adapter that is removably secured to any bottle such that a spray gun can be attached to spray the contents as a mist onto a food substrate such as hamburgers, steak or fish or a vegetable.

It is a third object to provide an adapter for large flexible bottles such as mouthwash bottles to serve as a fluid reservoir for spray delivery of a fluid disposed therein, for food flavor enhancement, fire fighting, and even odor reduction, when connected to a specific prior art spray gun.

These and other objects will in part be obvious and will in part be set forth herein.

The invention accordingly comprises the device possessing the features properties and the relation of components which are exemplified in the following detailed disclosure and the scope of the application of which will be indicated in the appended claims.

For a fuller understanding of the nature and objects of the invention reference should be made to the following detailed description, taken in conjunction with the accompanying drawings.

### SUMMARY OF THE INVENTION

A flexible adapter sized primarily for beer and soda bottles to permit the threaded attachment of a specific spray gun such that the content found in the bottle, be it original or replacement fluid can be sprayed out using a specific type of prior art spray gun. The gun should have a piston capacity of between 0.9 and 5 ml, with 3.5 ml, being deemed ideal for the intended purpose of accenting foodstuffs.

### BRIEF DESCRIPTION OF THE FIGURES

FIG. 1 is a perspective view of a first embodiment of this invention.

FIG. 2 is a sectional view of the first embodiment of this invention.

FIG. 3 is a perspective view of two of the manufactured end product of this invention.

FIG. 4 is a view similar to FIG. 3 of a second embodiment.

FIG. 5 is an elevational view of the third embodiment of the invention.

FIG. 6 is a view similar to that of FIG. 5 but of the 4^{th} embodiment and with the spray head attachment connected to thereto.

FIG. 7 is a bottom plan view of the 3^{rd} and 4^{th} embodiments.

FIG. 8 is an assembled view of a long neck beer bottle adapted into a spray bottle using the adapter of this invention and a specific spray head.

FIG. 9 is an assembled view of a short necked soda bottle adapted into a spray bottle using the adapter of this invention

FIG. 10 is a closeup perspective view of a preferred version of the spray head suitable for this invention.

### DESCRIPTION OF THE PREFERRED EMBODIMENT INTRODUCTION

The device of this invention has been made in both as a one piece unit and as a two part unit, either cemented or fused together. The units can be cast or molded of suitable flexible plastic material as will be described. As shown in one of the FIGURES, a 4 cavity mold was used to prepare the two one piece units. The first two embodiments, which are the one piece units, are the exact same in all details, but the second embodiment has been embellished by the incorporation of a pressure relief opening, as will be described more fully infra. The terms body portion and lower portion of the device are interchangeable.

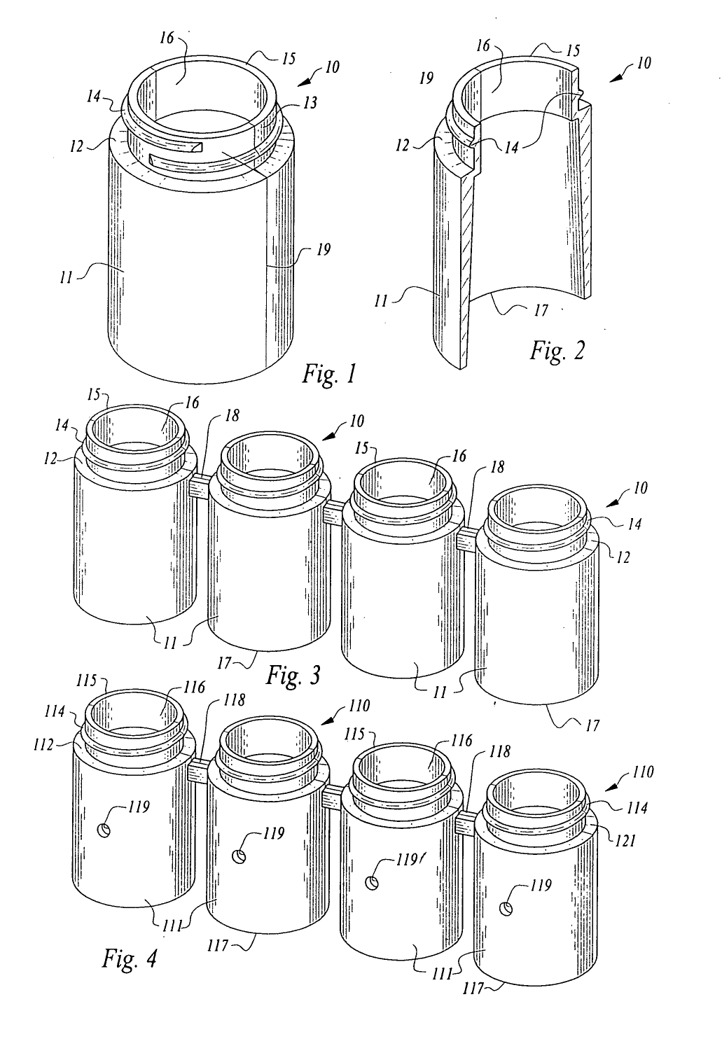

In FIG. 1, the first of the one piece units of this invention is seen. Device 10 has an elongated tubular body 11, with a shoulder designated 12. A cylindrical area 13 is denoted as the neck and has a diameter slightly smaller than the diameter of body 11. A set of threads for engagement are disposed on the outer surface of the neck area. The neck further includes a top edge 15 which of a smaller diameter than the shoulder 12 or the bottom edge 17, the latter being seen in the cross-sectional view of FIG. 2. Mold line 19 is the result of using a mold having two parts, and is quite normal for the art.

FIG. 3, and FIG. 4 is a dual view of both of the two different embodiments. These views illustrate the way the devices of this invention exit from a mold. Element 18 is a mold joint, and as can be seen there are 3 of these joints which would be present in a 4 cavity mold. FIG. 4 illustrates the second embodiment in perspective. All elements of the second embodiment are the same as the corresponding element of the first embodiment, but for the change from numbering in the 10″s to numbering in the 100 series. Therefore the description of each element need not be repeated. The sole addition that differentiates the second embodiment from the first embodiment is the presence of element 119 which is a pressure relief bore. One or two of these may be present, with the second such bore being disposed 180 degrees opposite the first such bore. The pressure relief bore(s) may be disposed at any suitable point in the elevation of the body 11 of the device.

When the device and the spray gun are utilized with bottled carbonated beverages such as Coca Cola® or any brand of beer especially when such beverages are at room temperature, wherein the contained carbonation easily separates from the fluid, the pressure relief bores allows the CO₂ gas to escape such that a pressure buildup is avoided. Such pressure will arise when a chef uses Coca Cola as a flavorant for barbecuing pork ribs or beef ribs.

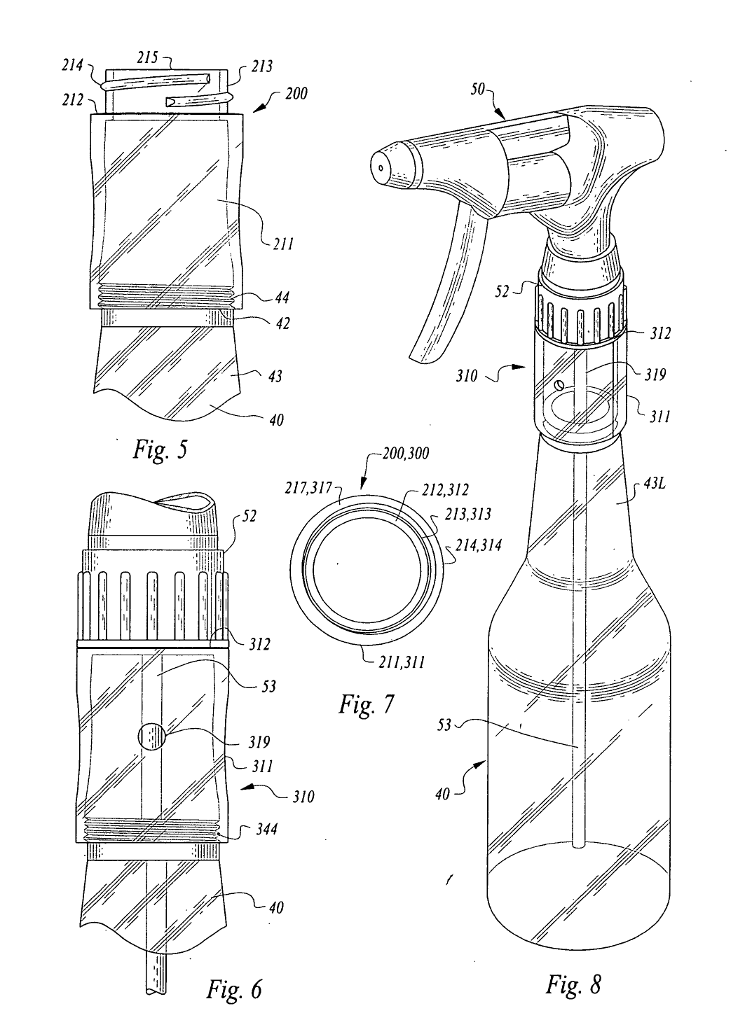

FIG. 5 is a closeup elevational view of the third embodiment of the invention which is a two part adapter disposed upon the top of a threaded beverage bottle. Thus seen in this view from the bottom of the page up, is a beverage bottle 40 having an extended neck 43 with an outward extending shoulder 42 at the top thereof, above which shoulder is a series of threads 44. Device 200 has a body portion 211 which is frictionally engaged at its lower or proximal end, upon the threads 44 of the bottle. At the upper or proximal end of device 200 is a shelf 215 which is a horizontal circular area, above which is a threaded area 212 which consists of a set of a male threads 214 of a slightly lesser diameter than body portion 211. Between each individual outward extending thread or ridge 214 of the threaded area 212 is a recess 213.

In this embodiment the body 211 may be made of a flexible preferably clear plastic such as low density polyethylene, while the upper male threaded portion is a clear rigid plastic. The device 211 is formed by pouring the two ingredients into a mold and letting them meld together at the interface in the mold. As an alternative the threaded area can be chemically fused to the body portion.

In FIG. 6 another 2 part device, 310, is seen. In most aspects it resembles those of the device having 200 series numbers. Here however, at least 1 vent hole 319 is formed in the side wall 311 of the device. This hole 319 serves as a pressure relief opening when the content of the bottle 40 contains pressurized liquid such as Pepsi-Cola®. Also seen in this FIG. 6 is a cap 52 threadedly engaged to the male threads 344 of this bottle. A feed tube or filler tube 53 is seen disposed through cap 52 down through device 310 into the bottle 40. The upper end of this tube 53 is connected to a spray gun, not seen in this view.

FIG. 7 is a bottom plan view of both embodiments 3 and 4. As such this view carries two sets of element numbers in both the 200 and the 300 series. Edge 217/317 is the bottom or underside edge of the two part device of this invention. The threaded area 212/312 consists of recesses 213/313 which lie between each outward extending ridge 214. The reader's attention is drawn to the slight color distinction between the body 211/311 and the threaded area 21/312. The presence or absence of one or more pressure relief bores or holes can not be discerned in this view. Hence the dual numbering.

In FIG. 8 a long neck unthreaded bottle 40L is seen. Such a bottle has a neck 43L, a shoulder 42 and an unthreaded area above the shoulder 48, which would be capped off by a removable cap using a conventional bottle opener. Seen frictionally engaged over, the bottle shoulder 42 is a device 310 according to this invention, which is a two piece unit with at least one vent hole. Note the presence of a bore 319 in the elevation of the body portion 311 of this device. Threadedly engaged over the unseen threaded area 312 is the female threaded cap 52 of semi-conventional spray gun 50. The term semi-conventional is intended to signify that while spray guns are readily available this time.

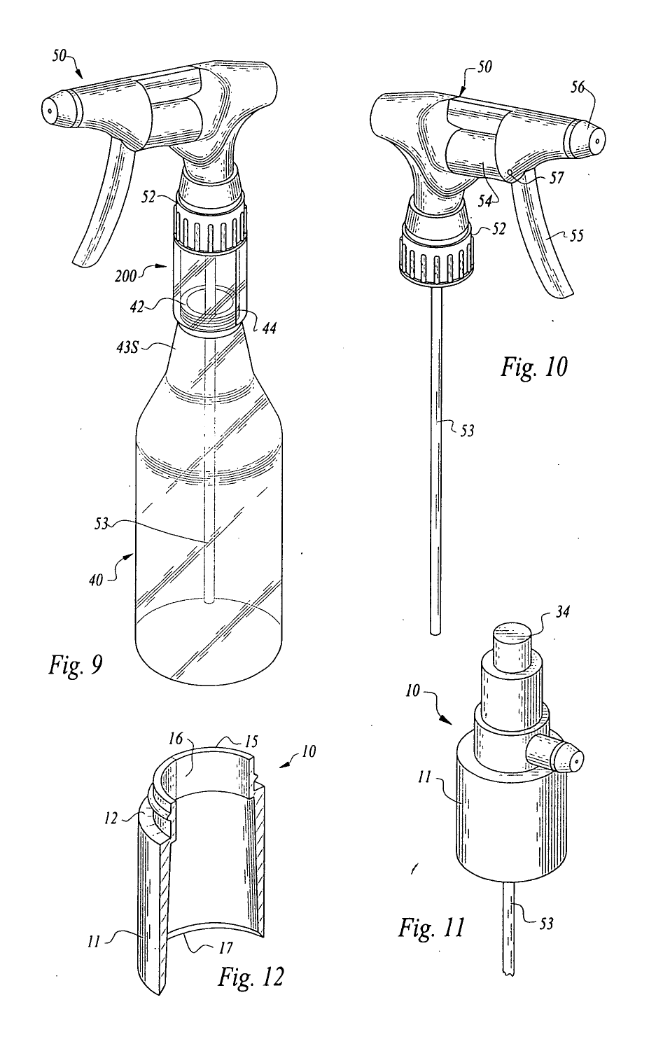

FIG. 9 is a view related to FIG. 8 but of a short necked bottle 40 have a short neck 43S, a shoulder 42 as discussed previously and threaded upper area 44. It should be pointed out that both shot necks bottles and long neck bottles both can have either a threaded or unthreaded upper area. Threaded bottles use a screw cap as the closure. Unthreaded bottles use a conventional bottle cap closure.

Here the threaded area 48 of short neck bottle 40 is overlaid with device 200, a two piece device with no vent holes. Typically a dark bottle with short neck which would use the no hole invention would be a bottle for barbecue sauce. Seen partially engaged to the threads 44 of device 200 is cap 52 of spray gun 50, only a part of which is seen in this figure. Filer tube 53 is seen extending down through the cap 52, through the clear device 200 into the colored short neck bottle 40S.

FIG. 10 depicts a side elevational view of a suitable spray gun for this invention. Gun 50 includes a rotatable nozzle 56 that can move between an open and a closed position. Trigger 55 pivots on pivot point 57 such that a piston arm unseen is engaged with a piston arm in cylinder 54 to urge the content that was drawn up through tube 53 out the nozzle. 56. This action is deemed conventional and no further discussion on the actuation mechanism need be recited. An early version of the modern trigger sprayer is disclosed and claimed in U.S. Pat. No. 3,897,006. What does need to be pointed out however is the physical size of the piston chamber. It has been found that a chamber of about 3.00 to 3.50 ml gives the best results. Smaller chambers below the recited range, will work obviously but will require too many squeezes of the trigger to place an adequate amount of liquid upon the food being prepared. While chambers over 4.00 ml are not only difficult to find, but could add too much of a flavorant or additive, should even a partial trigger squeeze take place.

FIG. 11 depicts a pump sprayer, which requires a downward pressure of the finger to operate. These are usually employed for the delivery of viscous liquids such as hand lotion or liquid soap. In the food arena, such an actuator could be used to deliver viscous fluids such as barbecue sauce, mustard or catsup among other flavorants. Early patents that disclose and claim such pump sprayers include Anderson U.S. Pat. No. 4,051,983 and Montaner et al U.S. Pat. No. 5,425,476.

FIG. 12 depicts a variation in the tubular portion of either the one piece or two piece device. Rather than being smooth and full walled at the very lower edge of thereof, if the tubular portion interior surface is slightly chamfered for about ¼ inch with the taper being widest at the very bottom, a bottle can be eased into the tubular portion with less effort than if no taper or chamfer is present.

It should be noted that some of the pump sprayers utilize a different thread area for the cap section and as such the devices of this invention would require a slight modification as to the threaded area. However, such modification is well within the skill of the artisan in this field.

Now for some specifics about the sizing and materials to be utilized in the preferred embodiment of these devices [with and without vent hole(s)] Soda and beer bottles are available in both plastic and glass. Plastic bottles almost always have a screw closure, while glass bottles can have either a cap type closure or a screw closure. Whether the bottle is glass or plastic, long neck or short, in most instances the screw caps are limited to but a few sizes. An English language publication by Gosdar Mfg. Co., Ltd located in Guangzhou, People's Republic of China notes that threaded cap closure sizes are generally expressed as two numbers. The first number refers to the cap diameter in millimeters, and the corresponding Glass Packaging Institute (GPU)/Society of the Plastics Industry (SPI) finish diameter. The second number refers to the right and thread configuration of the closoure or finish. For this invention, applicant may use any of three different closures all of the same diameter, 28 mm. The second number can be any of 400,410 or 415. The 400 unit has basically but one complete thread. The 410 has 2 threads and the 415 has 3 threads. But expressed on a threads per inch basis the 28/400 uses 6 threads per inch, while the next two have higher thread count.

Since the bottle of soda/beer or barbecue or other liquid is quite heavy relative to the spray gun, a tight fit of the cap to the top of the devices of this invention is needed. Applicant has found that a threaded area elevation of about 1.00 inch makes for a secure fit. The elevation of the total devices of this invention may vary from 1.75 inches to 2.25 inches with an inside diameter of the tubular lower portion being about 1.00 inches internal diameter and about 1.25 outside diameter.

Previously it has been stated that for the two part units, they can be chemically fused together. It has been found that a friction fit will also hold the threaded area to the tubular portion. In such an instance, the outside diameter of the threaded area at an unthreaded sectgon should be about 1.0625 inches to be forced into a 1.00 inch tubular portion such that retention takes place.

As to materials, employed, both the one piece and 2 piece devices of this invention are made of food grade plastic. Typical plastic used for the one piece unit is a food grade polyether based urethane such as, Texin® 985 made by Farben Bayer and having a Shore A hardness of 85. Another food grade material that may be suitable is a thermoplastic originally made by Monstanto Chemical and now made by Exxon Mobil, sold under the name Santoprene which has a Shore A hardness of 73. Other semi-flexible materials can also be employed. For the two piece unit, made by a process called overmolding or 2-shot molding, the threaded portion at the top may be made of a harder more rigid plastic such as a polycarbonate or cross-linked polyethylene, while the lower flexible tube area may be made of the previous or other food grade flexible rubber like plastics.

With respect tot he size of the spray gun's piston, it has already been indicated that a capacity of about 3.50 millimeters is desired. Spray guns, also known as trigger sprayers having large capacity pistons suitable for this invention are manufactured or distributed by such vendors as Freund Container, which offers item 3033C12 in any of 3 colors.

It was mentioned as a third object, to provide an adapter for large flexible bottles such as mouthwash bottles to serve as a fluid reservoir for spray delivery of a fluid disposed therein, for food flavor enhancement, fire fighting, and even odor reduction, when connected to a specific prior art spray gun. The caveat to this is that the opening of the bottle must coincide with the opening of a beer or soda bottle, in order to have the preferred embodiment of this invention's flexible lower portion engage the bottle opening. It should also be noted that if the bottle is glass, there is the risk that with a 24 or 32 ounce glass bottle or even a 2 liter soda glass bottle, that the weight of the bottle and its contents might be too heavy to permit the spray gun with the adapter of this invention interposed, to grip the bottle when lifted off a surface such as a table. In such an instance the glass bottle would fall to the ground. A 1.5 liter or 2 liter plastic large bottle however, is believed to be capable of being frictionally retained by the adapter when lifted off a surface. That would permit the spray gun to be attached to the upper or second portion of the adapter for use as described, for kitchen fire fighting, delivery of liquid to large surfaces, such as a whole suckling pig.

It is seen that I have created a new tool for the gourmet chef to be able to add liquid smoke, or just water or any liquid spice, or even soda, beer or whiskey to a food item that is being roasted or barbecued or baked. Now bourbon ribs are easy to prepare without the fear of too much alcohol that could catch on fire. Coke® flavoring for sweet potato casserole is now easy to add. And bottles big and small can be re-filled with water and sprayed at a needed location to put out small fires, without ruining the foodstuff being prepared.

Since certain changes may be made in the described apparatus without departing from the scope of the invention herein involved, it is intended that all matter contained in the above description and shown in the accompanying drawings shall be interpreted as illustrative and not in a limiting sense

I claim:

1. An adapter, to be interposed between a soda/beer bottle or other bottle having one of a long neck or a short neck and which bottle uses a closure to retain the liquid contents therein, and, a spray gun for delivering liquid contents from a bottle in small doses to a food item, said adapter having a flexible tubular lower portion which frictionally engages a bottle's top opening, and a male threaded upper portion, adapted to threadedly engage a spray gun for engagement to said threaded portion.

2. The adapter of claim 1, wherein the device is a one piece unit, having an elevation of between 1.50 and 2.25 inches and the neck finish is selected from the group consisting of from 28/400, 28/410 and 28/415.

3. The adapter of claim 2 wherein the neck finish is 28/400 with 6 threads per inch.

4. In combination a soda/beer bottle having a short or long neck and a bottle cap closure unthreaded opening, and a spray gun having a feed tube, and having a piston volume of about 3.50 ml., and an adapter interposed and connected to both the bottle opening and the spray gun, such that the feed tube is disposed within the confines of the bottle, whereby actuation of the spray gun will transfer fluid content from the bottle when fluid is present therein.

5. In combination a soda/beer bottle having a short or long neck and a screw cap closure threaded opening, and a spray gun having a feed tube, and having a piston volume of about 3.50 ml., and an adapter interposed and connected to both the bottle opening and the spray gun, such that the feed tube is disposed within the confines of the bottle, whereby actuation of the spray gun will transfer fluid content from the bottle when fluid is present therein.

6. In the combination of claim 4 wherein spray gun has a rotatable female threaded portion, and the bottle has a shoulder spaced down from the opening thereof, and the adapter has a flexible body portion which frictionally engages said shoulder and said opening, and the adapter has a male threaded upper portion adapted to engage the female threaded portion of the spray gun.

7. In the combination of claim 5 wherein spray gun has a rotatable female threaded portion, and the bottle has a shoulder spaced down from the threaded opening thereof, and the adapter has a flexible body portion which frictionally engages said shoulder and said threaded opening, and the adapter has a male threaded upper portion adapted to engage the female threaded portion of the spray gun.

8. An adapter as I claim 1 wherein the device has a flexible lower tubular portion sized to engage the opening of a soda/beer bottle and a threaded upper portion sized to engage a spray gun.

9. The device of claim 8 wherein from 1 to 2 vent holes are present in the lower portion to permit the venting of gas from a carbonated beverage that may be present in a bottle to which the adapter is to be engaged.

10. The device of claim 8 wherein the device is a one piece unit, having an elevation of between 1.50 and 2.25 inches and the neck finish is selected from the group consisting of from 28/400, 28/410 and 28/415.

11. The device of claim 9 wherein the device is a one piece unit, having an elevation of between 1.50 and 2.25 inches and the neck finish is selected from the group consisting of from 28/400, 28/410 and 28/415.

12. The adapter of claim 8 wherein the device is formed of two portions united into an integral structure.
